(19) United States
(12) Patent Application Publication
(10) Pub. No.: US 2015/0336739 A1
(43) Pub. Date: Nov. 26, 2015

(54) CONFIGURABLE CONTAINER SYSTEM

(71) Applicant: Rubbermaid Commercial Products, LLC, Winchester, VA (US)

(72) Inventors: Donald C. Presnell, Stephens City, VA (US); Jarret D. Chirafisi, Winchester, VA (US)

(21) Appl. No.: 14/705,370

(22) Filed: May 6, 2015

Related U.S. Application Data
(60) Provisional application No. 61/989,664, filed on May 7, 2014.

(51) Int. Cl. B65F 1/00; B65F 1/14; B65F 1/02

(52) U.S. Cl. CPC B65F 1/0053; B65F 1/02; B65F 1/1646; B65F 2001/0086

(57) ABSTRACT

The system comprises a plurality of individual containers usable together to create a configurable and reconfigurable system. Each container may comprise a base that supports a body and a top located on the body. The bases may be provided in a plurality of different sizes such that the system may be configured to meet the user's space, floor plan needs, and processes. In one embodiment the sizes of the bases are related such that the bases may be combined to create a unified system. The containers are connected together by a releasable connection mechanism that may include magnets. The containers are aligned relative to one another by an alignment mechanism that may include a protrusion on one container that engages a recess on the adjacent container.

This application claims benefit of priority under 35 U.S.C. §119(e) to the filing date of U.S. Provisional Application No. 61/989,664, as filed on May 7, 2014, which is incorporated herein by reference in its entirety.

### BACKGROUND

Containers are known for disposing of trash, recyclables or other discarded items. Some containers are used in applications where individual containers are intended to receive specific types of articles such as paper, plastic, cardboard, non-recyclables or the like.

### SUMMARY OF THE INVENTION

In one embodiment a configurable container system comprises a first container having a first opening allowing access to the interior of the first container and a second container having a second opening allowing access to the interior of the second container. A first magnet provided on the first container and a magnetically attractive connector provided on the second container releasably secure the first container to the second container.

The magnetically attractive connector may comprise a ferromagnetic material. The first magnet may have a first polarity and the magnetically attractive connector may comprise a second magnet having a second polarity. The configurable container system of claim 1 comprising an alignment mechanism on the first container and the second container for aligning the first container relative to the second container. The alignment mechanism may comprise a protrusion on one of the first container and the second container and a recess on the other one of the first container and the second container. The protrusion may comprise a rounded convex protrusion and the recess may comprise a rounded concave recess. The alignment mechanism may comprise a protrusion on one of the first container and the second container and a recess on the other one of the first container and the second container and the first magnet may comprise one of the protrusion and the recess and the magnetically attractive connector may comprise the other one of the protrusion and the recess. The first magnet and the magnetically attractive connector may be disposed opposite to one another when the alignment mechanisms of the first container and the second container are engaged with one another. The first container may have a depth of a basic unit and a width of the basic unit and the second container may have a second width and a second depth where at least one of the second width and the second depth is an integer multiple of the basic unit. The first container may have a first top and the second container may have a second top, the first opening being in the first top and the second opening being in the second top wherein one of the first top and the second top may comprise a first section connected to a second section at a hinge such that the first section may move relative to the second section about the hinge to change the angle of the one of the first top and the second top relative to the first container and the second container, respectively. The first container may comprise a body and a door in the body. The first container may comprise at least a first wall panel and a second wall panel where the first wall panel and the second wall panel are independently connected to a base. The first wall panel may comprise a pivoting door. The first wall panel may comprise a frame supporting a pivoting door. The first container and the second container each may comprise a triangular base supporting a triangular body wherein the first container and the second container are connected by engagement of the first magnet and the magnetically attractive connector to create a system having a rectangular footprint. The first container and the second container may each comprise a base supporting a body wherein the body comprises a flexible fabric supported on a rigid frame.

In some embodiments, a configurable container system comprises a first container having a first opening allowing access to the interior of the first container and a second container having a second opening allowing access to the interior of the second container. A connection mechanism releasably secures the first container to the second container. An alignment mechanism aligns the first container and the second container and comprises a protrusion on one of the first container and the second container and a mating recess on the other one of the first container and the second container.

The protrusion may comprise a magnet where the recess receives the magnet. The protrusion may comprise a convex protrusion and the recess may comprise a mating convex recess.

### BRIEF DESCRIPTION OF THE DRAWINGS

FIG. 1 is a perspective view of an embodiment of the configurable container system of the invention.

FIGS. 2A and 2B are perspective views showing alternate configurations of another embodiment of the configurable container system of the invention.

FIG. 3 is a perspective view of the configurable container system of FIG. 1 in a second configuration.

FIGS. 4 and 5 are perspective views showing embodiments of a container construction usable in the configurable container system of FIG. 1 and a method of assembling the containers.

FIG. 6 is a perspective view of the configurable container system of FIG. 1 in a third configuration.

FIGS. 7 through 12 are perspective views of different embodiments of the connection mechanisms and alignment mechanisms used in the configurable container system of FIG. 1.

FIG. 13 is a perspective view showing an embodiment of a container used in the configurable container system of FIG. 1.

FIGS. 14 and 14A are perspective views showing embodiments of containers usable in the configurable container system of FIG. 1.

FIGS. 15A through 15D show various embodiments of the side wall panels usable in the containers used in the configurable container system of FIG. 1.

FIG. 16 is a perspective view of another embodiment of the configurable container system of the invention.

FIG. 17 is a perspective view of still another embodiment of the configurable container system of the invention.

### DETAILED DESCRIPTION OF EMBODIMENTS OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

Relative terms such as “below” or “above” or “upper” or “lower” or “horizontal” or “vertical” or “top” or “bottom” may be used herein to describe a relationship of one element, component or region to another element, component or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. It will be further understood that the terms “comprises” “comprising,” “includes” and/or “including” when used herein, specify the presence of stated features, steps, operations, elements, and/or components, but do not preclude the presence or addition of one or more other features, steps, operations, elements, components, and/or groups thereof.

The container system of the invention provides a configurable and reconfigurable system that may be customized to meet the end user's needs. In one embodiment the container system may be used for recycling and trash handling and may be configured to meet the end user's processes, such as matching particular recycling streams with appropriate volume collection, and to adapt the container system to the user's floor plan.

The system comprises a plurality of individual containers usable together to create a configurable and reconfigurable system. Each container may comprise a base that supports a body comprising a vertical walls. A top is located on each body. The bases may be provided in a plurality of different sizes such that the system may be configured to meet the user's space, floor plan needs, and processes. In one embodiment the sizes of the bases are related such that the bases may be combined to create a unified system. For example, each base may define an area that is an integer multiple of the area of the smallest base.

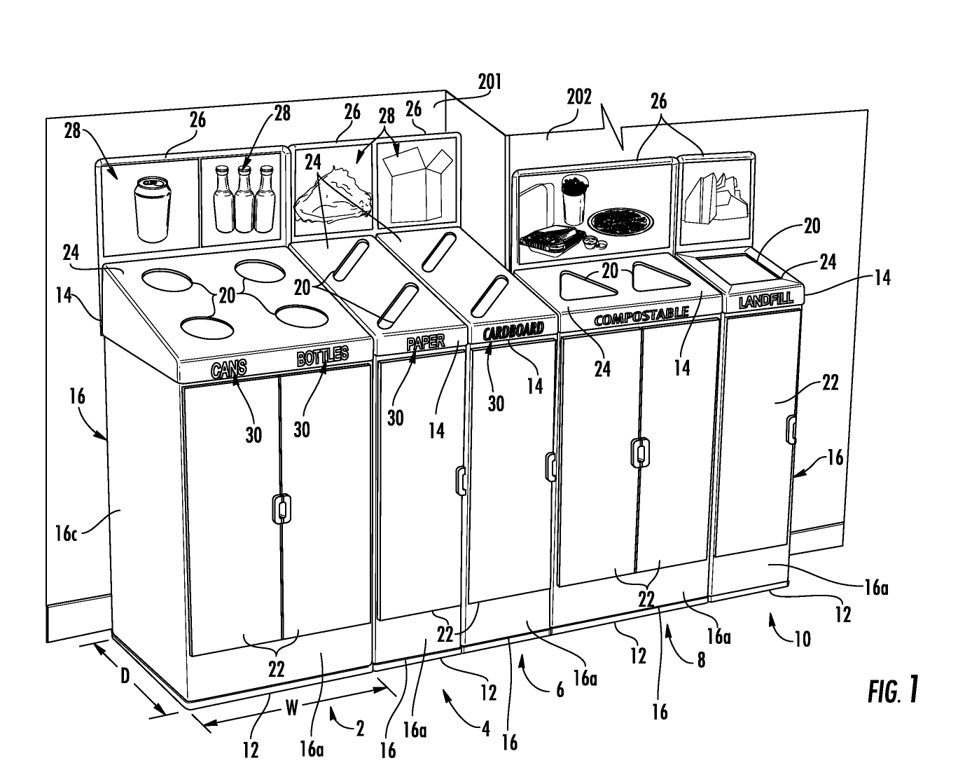

One embodiment of the system is shown in FIG. 1 where five containers 2, 4, 6, 8 and 10 are shown forming a single, unified system where container 10 defines the smallest container in the system and container 2 defines the largest container in the system. Each container has a body 16 supported on a base 12 that supports a top 14. The body 16 is defined by vertical side walls that in the rectilinear container of FIG. 1 comprises four side walls defined by a front wall 16a and back wall 16b joined by two side walls 16c, 16d.

Container 2 comprises a base 12 that comprises a two-by-two (2×2) base where the base has a depth D of two basic units and a width W of two basic units. The basic units may comprise any suitable units and dimension to define a base of a particular size. The system comprises a second size container 4 that is a 1×2 container having a width of one basic unit and a depth of two basic units. The system as shown in FIG. 1 comprises a second 1×2 container 6 that has the same configuration as container 4. The two 1×2 containers 4 and 6 define a space that is approximately the same footprint and volume as one 2×2 container 2. The system may comprise a container 8 that is a 2×1 container having a width of two basic units and a depth of one basic unit. The system may also comprise a 1×1 container 10 having a width of one basic unit and a depth of one basic unit. Other containers may be provided in different sizes. In some embodiments the foot prints of the different size containers may be related as described above where the width and depth of the containers may be integer multiples of the smallest basic unit. In other embodiments the foot prints of the different size containers may be unrelated.

A top 14 may be supported on body 16 to create an interior space for receiving the recyclables, waste or other articles. The top 14, body 16 and base 12 may be made as separate components that are releasably connected to one another to create a complete container. The body 16 may also be made of separate side wall panels where each side wall 16a-16d of the body 16 comprises an independent component separately attached to base 12 and to top 14.

In one embodiment the top 14 defines openings 20 or other receptacles for receiving the recyclables, waste or other articles such that the articles may be deposited in the container. The openings 20 may have any suitable shape and may be shaped to conform to the shape of the article being received. The openings 20 may have movable covers or may be uncovered. The openings 20 may be arranged in a one-to-one relationship with the basic unit such that, for example, the top for a 2×2 container 2 has four receptacles, one for each basic unit. In other embodiments the openings may not be arranged in a one-to-one relationship with the basic unit such that the containers may have one, two, three or more openings 20 regardless of the footprint of the container. As shown in FIG. 1 one of the walls of the body 16 may be provided with a door or doors 22 such that access may be made to the interior of the container through the door 22. In one embodiment the door is provided in the front wall 16a to facilitate access to the interior of the container. Access may also be provided by making the top 14 removable such that a user may access the interior of the container through the open top.

In some embodiments, the interior of the containers may include a support structure such as a bail, rail or other similar supporting structuret for suspending a disposable receptacle such as a plastic bag liner. In some embodiments, the interior of the containers may support a reusable trash can that may in turn support a disposable receptacle such as a plastic bag liner. The door 22 may be opened such that the full bag liners may be removed and disposed of and replaced by a new bag liner. In other embodiments the internal reusable pail may be removed from the container, emptied and returned to the container.

In the embodiment of FIG. 1 the containers are designed to be disposed against a wall where the top surface 24 of tops 14 are angled such that the user has easy access to the entire volume of space defined by the container through any one of the openings 20 from one side of the container. Specifically, the top surface 24 is gradually angled upward from the front of the container toward the back of the container. A vertical signage space 26 is provided that may comprise a panel that extends upwardly from the back side wall 16b or the top 14. The signage space 26 may be formed as part of the top 14 or body 16 or it may be a separate component attached to the container. The signage space 26 may be provided with indicia 28 such as words, symbols, drawings, photographs or the like to indicate the appropriate receptacle for a particular type of waste, recyclable or other article. Indicia may also be provided on the top 14 or on the body 16 as shown at 30.

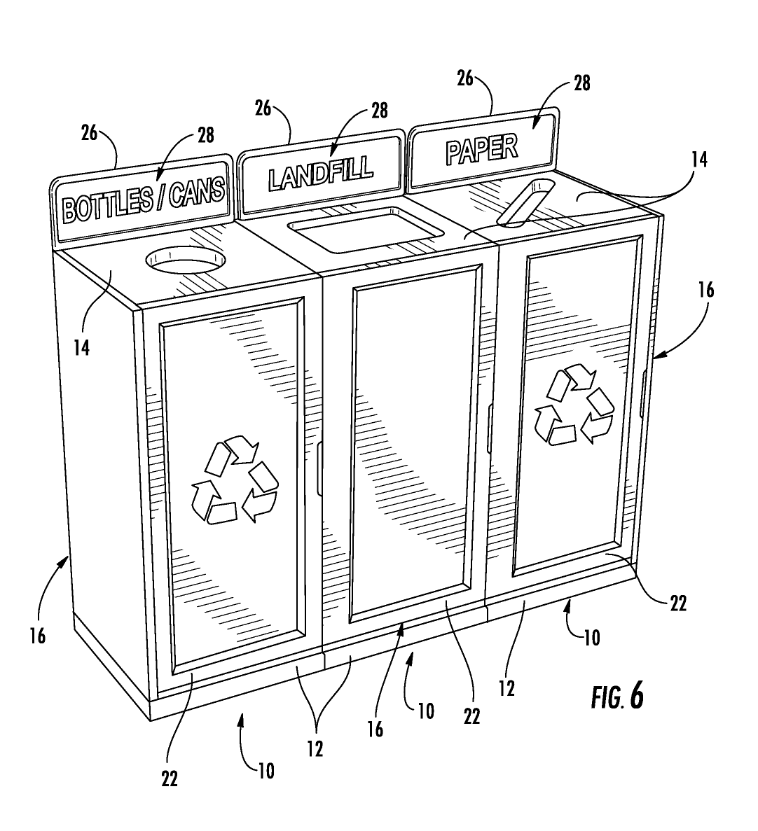

While a specific embodiment of the invention has been described with respect to FIG. 1, a variety of modifications may be made to the system. A greater or fewer number of containers may be used in a single system and the containers may be arranged in patterns other than those specifically shown and described. Moreover, other containers having different widths and depths than those specifically shown in FIG. 1 may be provided. The width and depth of all of the containers may be integer multiples of the smallest basic unit; however, the width and depth of the containers do not necessarily have to be integer multiples of the smallest basic unit. The openings 20 may take a wide variety of shapes and sizes. In one embodiment, the body 16, base 12 and top 14 may be made of a rigid material; however, a wide variety of materials may be used. FIG. 6 shows an alternate embodiment of a system having three of the same size containers where indicia of contents 28 are on the front door 22 and/or on the signage panels 26.

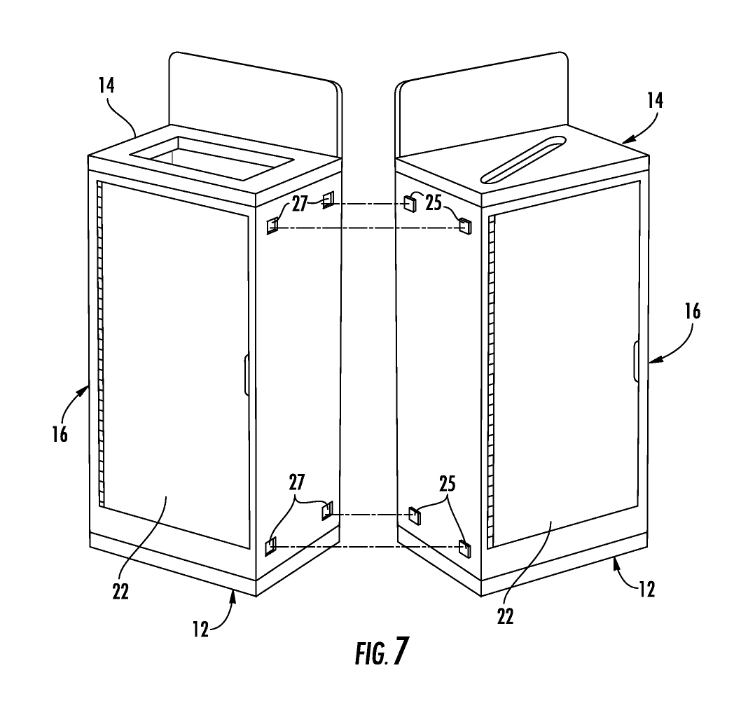

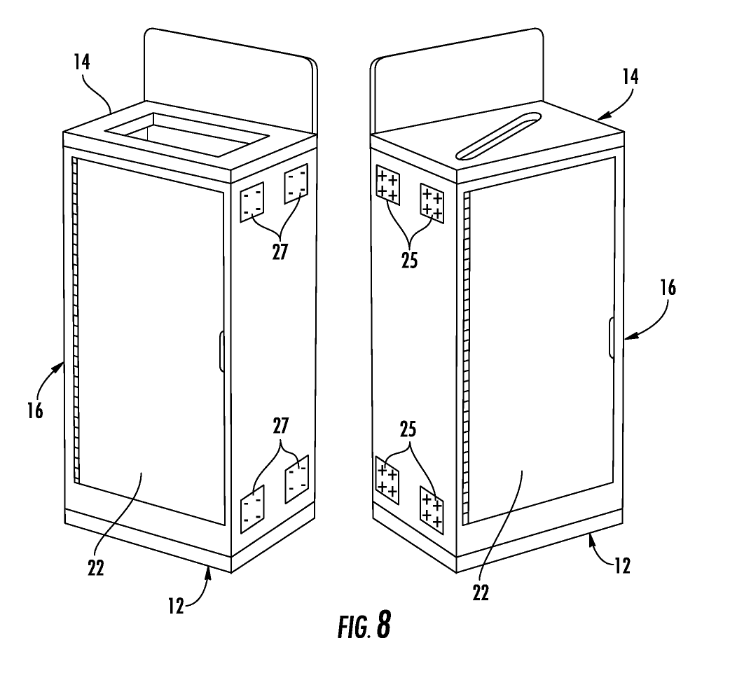

The base 12, body 16 and/or tops 14 of each container may comprise a connecting mechanism for connecting that container to an adjacent container such that all of the containers in a unified system are connected together. In one embodiment, magnets 25 are used as the connecting mechanisms to connect the adjacent containers to one another as shown in FIG. 7. The magnets 25 may be provided on the side walls 16c, 16d and/or the back wall 16b of the containers such that when one container is placed closely adjacent a second mating container the magnets 25 releasably secure the containers together such that the containers form a uniform, organized, unified system. In other embodiments the magnets 25 may be located on the sides of the tops 14 or the bases 12. In one embodiment a magnet 25 is provided on one wall of one container and a magnetically attractive connector 27 is provided in the same relative location on the facing wall of the adjacent container such that the magnet 25 of the first container attracts the magnetically attractive connector 27 of the second container. The magnetically attractive connector 27 may comprise a ferromagnetic material such as a plate of ferromagnetic material attached to the side wall of the container. In some embodiments the entire side wall may be made of a ferromagnetic material. The magnetically attractive connector 27 on the second container may also comprise a magnet having opposite polarity of the magnet 25 on the first container such that both containers comprise magnets as the mating connectors as shown in FIG. 8. A greater or fewer number of magnets 25 and magnetically attractive connectors 27 may be provided than shown in the figures and the placement of the magnets on the containers may be different than that shown in the figures.

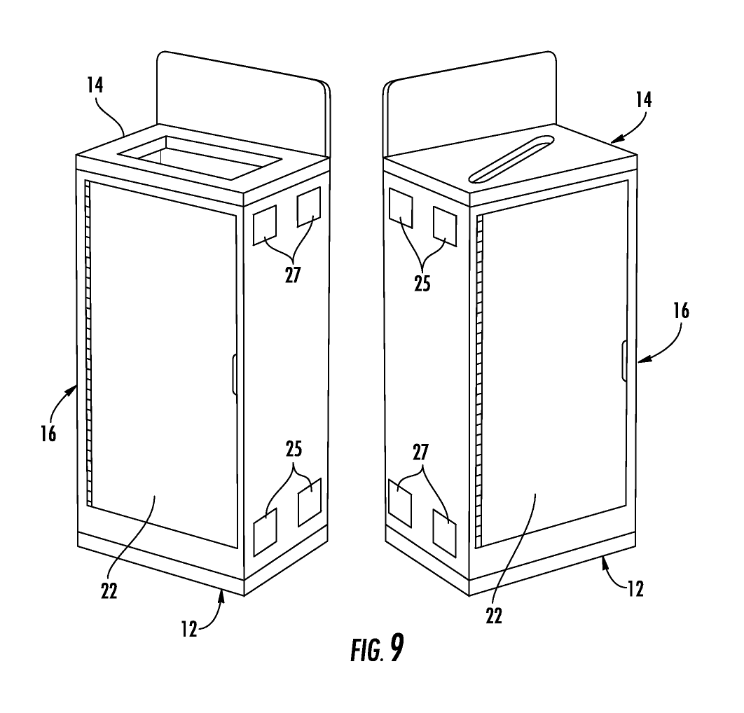

In some embodiments, the containers in a system may be uniformly made such that the left side wall of each container comprises the magnet 25 and the right side wall comprises the magnetically attractive connector 27 or visa versa. In this manner any container may be arranged on either side of any other container. In some embodiments the magnets and/or the magnetically attractive connectors may also be formed on the back walls 16b of the containers such that the containers may be arranged back to back or at right angles relative to one another. In embodiments where the side walls 16b-16d are separately attached to the base 12, the magnets 25 may be arranged on any one of the side walls and the magnetically attractive connectors 27 may be arranged on any one of the side walls of the adjacent container such that any wall of each container may comprise the magnet 25 or the magnetically attractive connector 27. In other embodiments, each of the side walls and/or back wall may be provided with both magnets 25 and the magnetically attractive connectors 27 as shown in FIG. 9.

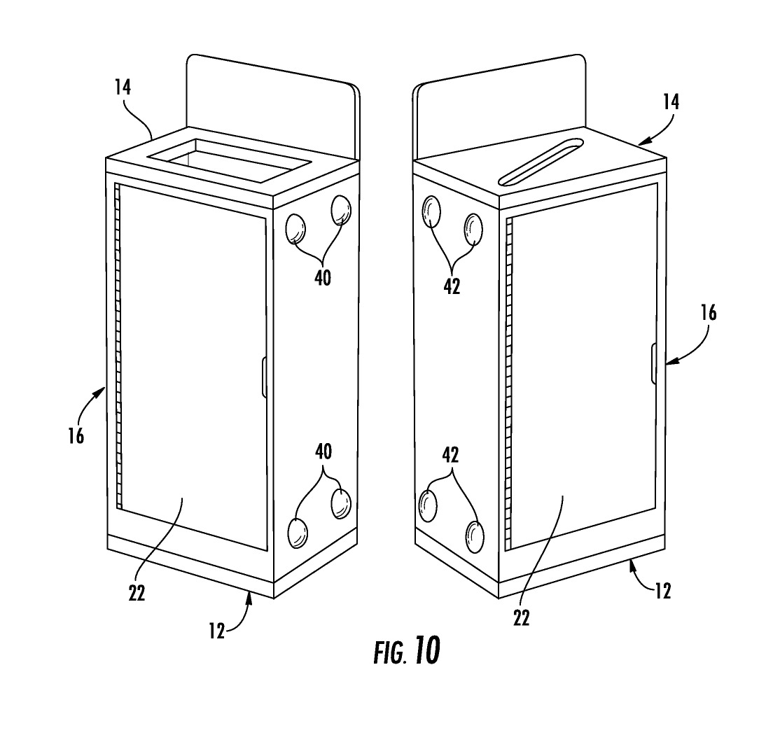

In order to align the containers and the magnets/magnetically attractive connectors of adjacent containers, the walls of the containers may be provided with alignment mechanisms. In one embodiment the alignment mechanisms comprise male protrusions 40 that extend from one of the side walls and/or back wall that are aligned with and engage mating female recesses 42 that are formed in the other one of the side walls and/or back wall as shown in FIG. 10. In one embodiment the protrusions 40 comprise rounded convex protrusions and the recesses 42 may comprise mating rounded concave recesses. The use of the rounded recesses and protrusions allows the containers to be slid into place relative to one another. In other embodiments the alignment mechanisms may have other shapes.

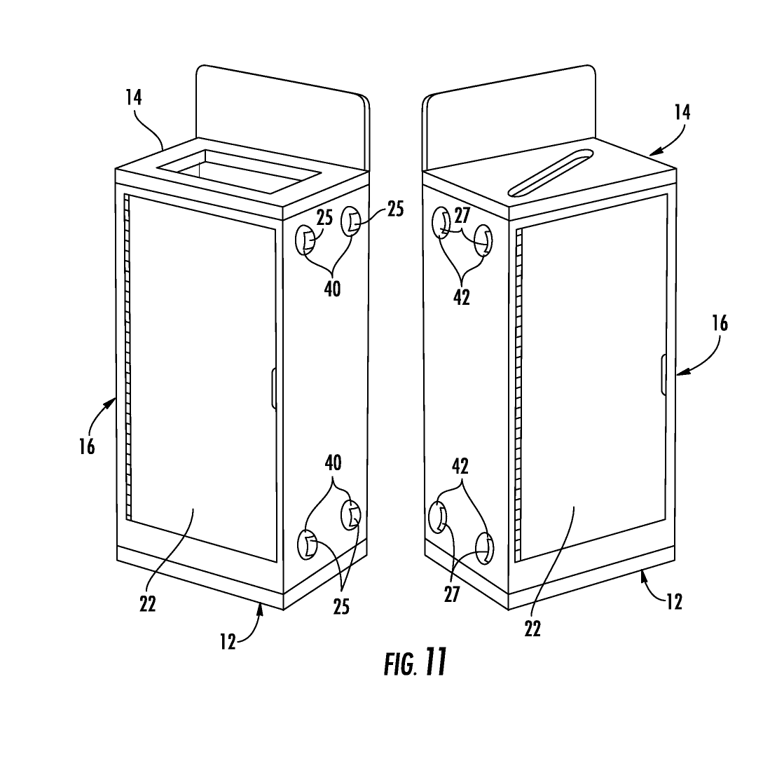

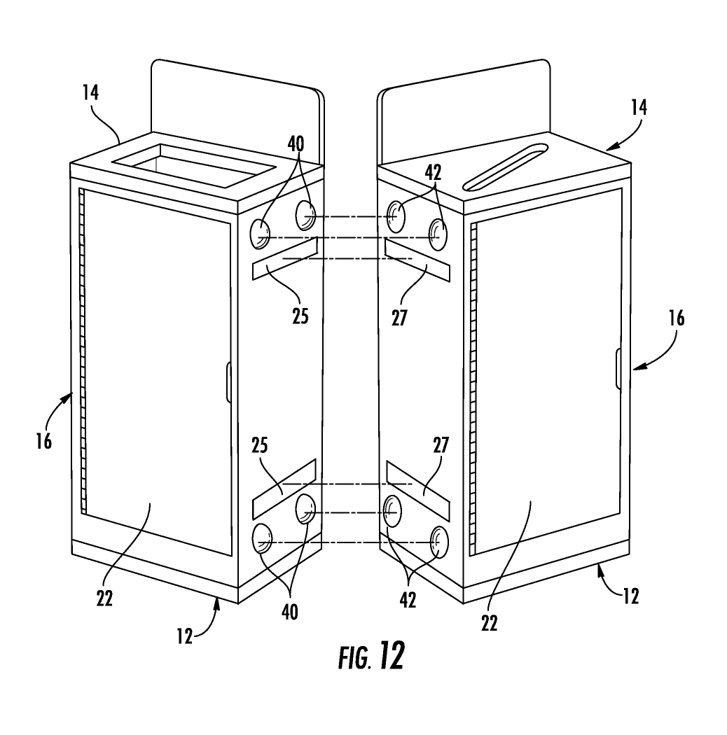

The magnets 25 and the magnetically attractive connectors 27 may be located in or form at least part of the mating alignment mechanisms 40, 42 such that the protrusions 40 and recesses 42 align adjacent containers relative to one another and position the magnets 25 and the magnetically attractive connectors 27 opposite to one another as shown in FIGS. 7 and 11. In the embodiment of FIG. 11 the alignment mechanisms 40 and 42 have the convex and concave shapes as previously described with the magnets 25 and the magnetically attractive connectors 27 formed as part of the alignment mechanisms 40, 42. In the embodiment of FIG. 7 the magnets 25 form the protrusions and have a rectilinear shape that engage mating rectilinear recesses formed on the opposed side wall. The recesses may form the magnetically attractive connectors 27. While the magnets 25 and the magnetically attractive connector 27 may be formed in or on the alignment mechanisms 40, 42, the magnets 25 and the magnetically attractive connectors 27 may be located at different positions on the side walls 16c, 16d and back walls 16b than the alignment mechanisms 40, 42 provided that the magnets 25 and the magnetically attractive connectors 27 are disposed opposite to one another when the alignment mechanisms 40, 42 of adjacent containers are engaged with one another as shown in FIG. 12.

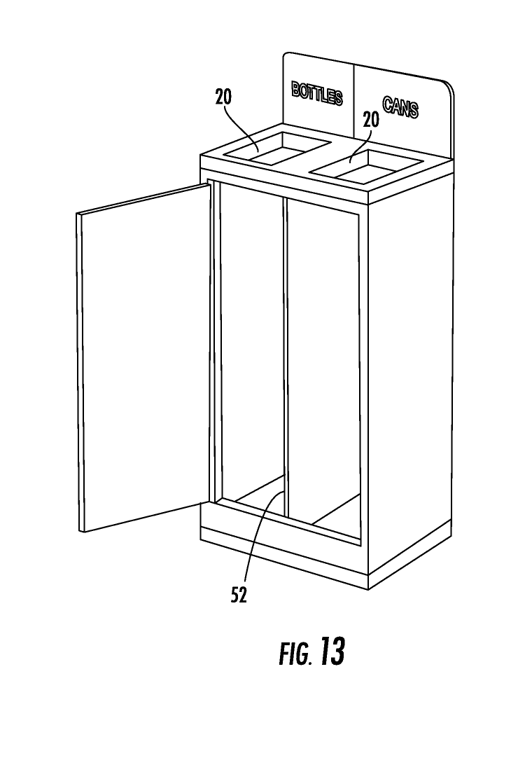

Other connection mechanisms in addition to or in place of the magnets may be used such as snap-fit connectors, pivoting latches, separate fasteners, friction fit connectors, or the like; however, the use of magnets as the connection mechanisms is a preferred embodiment that allows simple alignment, connection and disconnection of the containers. In some embodiments the containers may not be connected to one another; however, such an arrangement may not provide a unified organized system. Moreover, the door, while illustrated as a hinged door, may have a variety of configurations or may be eliminated. Further, in embodiments where the tops 14 have more than one opening 20 an internal wall 52 or divider may be used to separate the article streams inside of the container as shown in FIG. 13. For example, a divider 52 may be used inside of the container between the “Bottles” openings and the “Cans” openings.

One exemplary embodiment of the arrangement of the system of the invention is shown in FIG. 1 where the containers are disposed against a wall and are arranged to accommodate a jog in the wall where a first wall 200 is offset from a second wall 202. By arranging the containers having a smaller depth against the protruding wall 202 and the containers having a larger depth against the recessed wall 200 the system may present a planar front even where the wall is not planar while maximizing usable space. When used against a flat wall, containers of the same depth may be used such that the system presents a planar front as shown, for example, in FIG. 6; however, containers of differing depths may also be used.

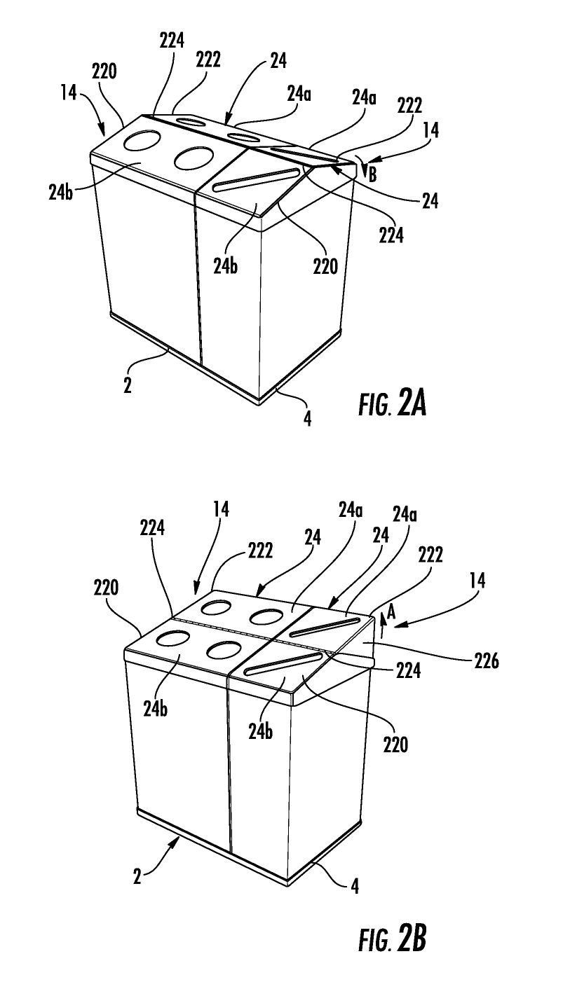

The system may be used against a wall as shown in FIG. 1 or as a free standing system with a surrounding traffic flow. The system is shown in a surrounding traffic flow configuration in FIG. 2a and in an against the wall configuration in FIG. 2b. FIG. 2b shows a system having a 2×2 container 2 and a 1×2 container 4 where the tops 14 of the containers are angled so as to provide easy access to the openings from one side of the container as previously described. In the arrangement of FIG. 2a the tops 24 of the containers 2 and 4, respectively, are angled such that one side 24a of each top is angled to provide easy access from a first side of the container and another side 24b of each top is angled to provide easy access from the other side of the container. The tops angle from the fronts of the system toward the center of the system such that the top walls meet at a peak that extends along the center of the system. This arrangement allows traffic to flow around both sides of the system while allowing easy access to the openings from either side of the system.

In one embodiment the tops may be made reconfigurable such that a single top component may be used to form both the configuration of the system shown in FIG. 2A and the configuration of the system shown in 2B. Such a reconfigurable top also allows the end user to configure and reconfigure the system on site without the need to purchase or store different components. The reconfigurable top comprises a first section 220 connected to a second section 222 at a hinge 224 extending along the peak of the tops as shown in FIG. 2A such that section 222 may rotate relative to section 220 about hinge 224. One or both of the sections 220, 222 may be rotated about the hinge 224 between a first “lowered” position and a second “raised” position. In the raised position the outer edge of the section is raised (Arrow A) above the hinged edge such that the top surface angles down from the outside of the container to the inside of the container as shown in FIG. 2B. In the lowered position the outer edge of the top surface is lowered (Arrow B) below the hinged edge such that the top surface angles down from the inside of the container to the outside of the container as shown in FIG. 2A. The reconfigurable top allows a single top to be used either as a wall unit or as a surrounding traffic flow unit. Locking mechanisms such as pin and holes, overcenter linkage, ball and detent may be used to lock the movable sections in either the raised or lowered positions. The side walls 226 of the movable sections may slide into the top 14 when the sections are in the lowered position. The side walls 226 of the movable sections may also be made collapsible. In some embodiments the sections 220, 222 may assume a horizontal position between the lowered position and the raised position.

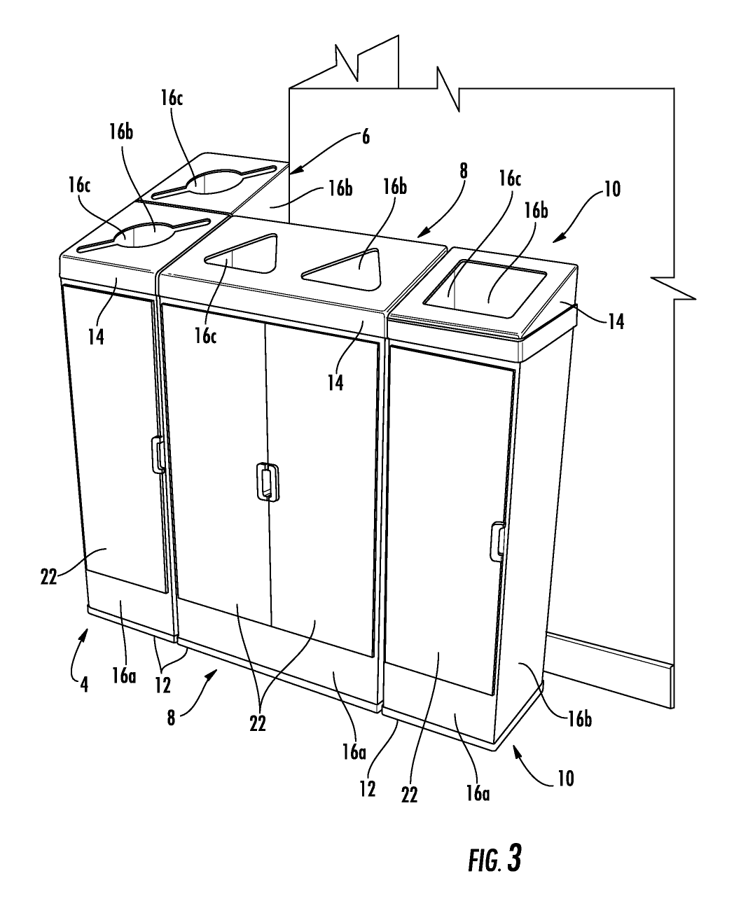

FIG. 3 shows a configuration of the system that is arranged to wrap around an exterior corner of a wall. In this arrangement a plurality of one unit deep containers (e.g. 8, 10) are disposed along a first wall and a two unit deep container 6 is disposed at the corner such that it extends along the second wall of the corner. Additional containers may be added to either end of the system. In this and in other embodiments the magnets and magnetically attractive connectors may be formed on all sides of the container or on any combination of sides of the container. Providing magnets and/or magnetically attractive connectors on all sides of the containers may be advantageously employed where the containers are not positioned in a straight line such as when wrapping around a corner as shown in FIG. 3; however, the use of magnets and/or magnetically attractive connectors on all sides of the containers may be employed in any use of the system. Where magnets and/or magnetically attractive connectors are used on all sides of the container, the door 22 may be eliminated and the refuse may be removed from the container by providing a removable top 14.

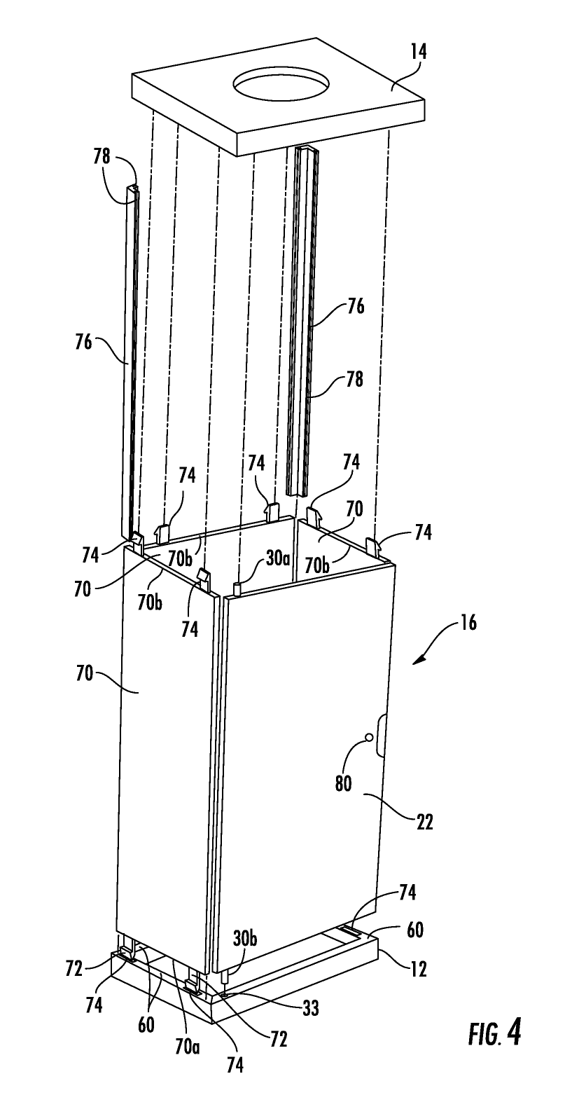

FIG. 4 discloses an embodiment of a container and a method of assembling the container that may be used with any of the containers described herein. In the illustrated embodiment a pivoting door 22 is provided on one side of a container 4. In such an embodiment three of the side walls of the body 16 may be identical, except for the width and depth dimension, and the fourth side wall of the body may contain or comprise the door 22. The three identical walls comprise a wall panel 70 having a lower edge 70a that may be inserted into a mating upwardly facing channel 60 formed in the base 12 to form the back wall 16b and side walls 16c, 16d. In one embodiment the lower edge 70a of each panel 70 is formed with a tab or tabs 72 that engage separate channels or slots 74 formed in the base 12 in a snap-fit connection. The panels 70 may include connection mechanisms to connect the panels to one another at the corners of the container such as snap-fit connectors, magnets, separate fasteners or the like. In one embodiment the connection mechanism includes a corner strip 76 that comprises two channels 78, one channel receiving each vertical edge of the adjacent panels 70 to lock the panels together. The corner strip 76 may be slid over the panels or it may be snapped onto the panels. The corner strip 76 may deform to engage the panels in a snap-fit connection.

In one embodiment the door 22 comprises coaxial aligned pivot pins 30a, 30b formed at a top and bottom edges of the door, respectively, that create the hinge. The bottom pin 30b may be inserted into a hole 33 formed on the base 12 and the top pin 30a may be inserted into a similar hole (not shown) formed on the top 14 such that the door 22 may pivot about the vertical axis defined by the top and bottom pins 30a, 30b. The top 14 may be installed on the panels by providing channels or slots in the top that are engaged by the top edge 70b of panels 70 or by tabs 74 as previously described with respect to base 12. The door may be locked in the closed position by a latch or keyed lock 80.

To assemble the container the wall panels may be inserted into base 12 such that the tabs 72 or bottom edge 70a of the wall panels 70 engage the channels or slots in the base 12. The wall panels 70 may be secured to one another along the corners of the container such as by attaching corner strips 76 to the vertical edges of the adjacent panels. The bottom pin 30b of the door 22 may be inserted into the hole 33 formed in the base 12. The top 12 may be fixed to the top edge 70b of the panels with the top pin 30 positioned in the hole formed in the top 12. The top 12 is positioned such that the top edges 70b of the panels engage downwardly facing channels formed in the top and/or the tabs 74 extending from the top edges 70b of the panels 70 engage downwardly facing slots formed in the top.

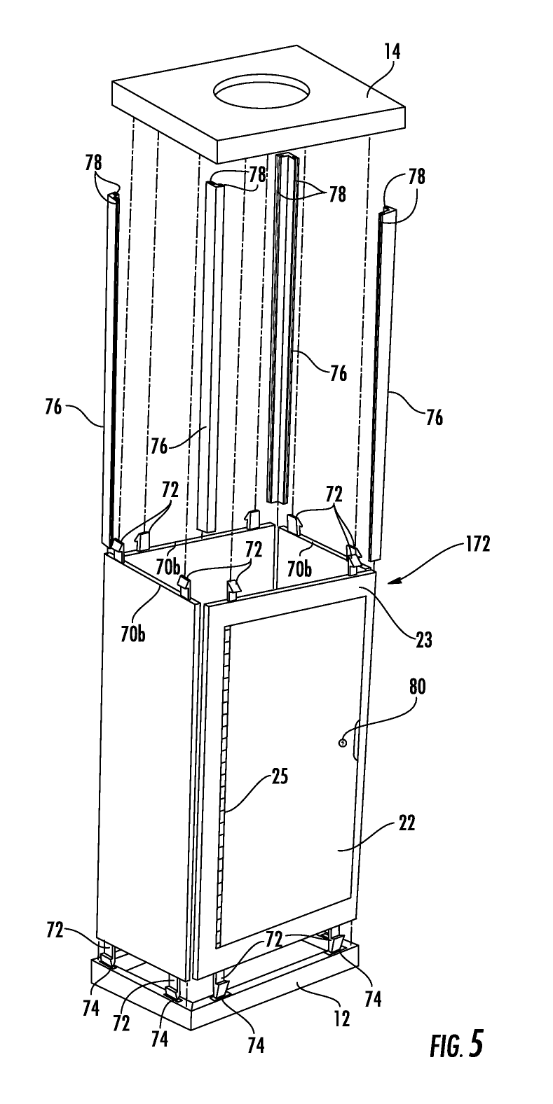

Referring to FIG. 5, in other embodiments the door 22 may be formed in a panel 172 comprising the door 22 pivoted to a frame 23 at a mechanical hinge 25 such that the door 22 pivots relative to the door frame 23. The panel 172 may be attached to the base 12, top 14 and the adjacent wall panels as previously described.

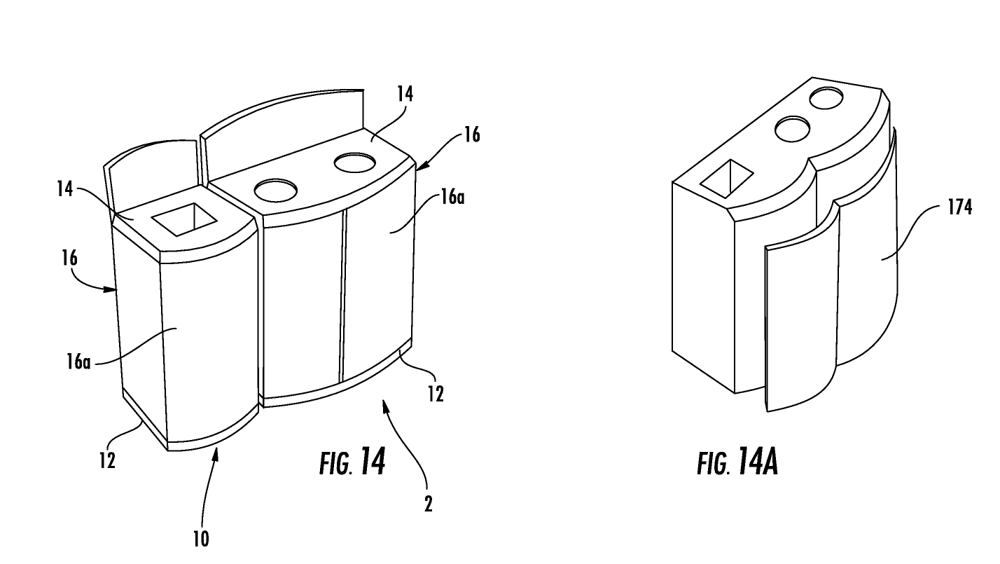

FIG. 14 discloses a system where the front walls 16a may be made curved or rounded to change the aesthetics of the containers. In one embodiment, a curved surface extending across a wide container may protrude farther than is desired. Thus, a small container, e.g. container 10, may have a more rounded front panel and a wide container, e.g. container 2, may have a softer curved front panel. The “softer curve” means a curve with a larger radius of curvature. The front of a wider container may also have a scalloped front panel 174 as shown in FIG. 14a where a single front panel is formed of two curved surfaces meeting at a vertical seam. The vertical seam may be formed in the center of the front wall of the container.

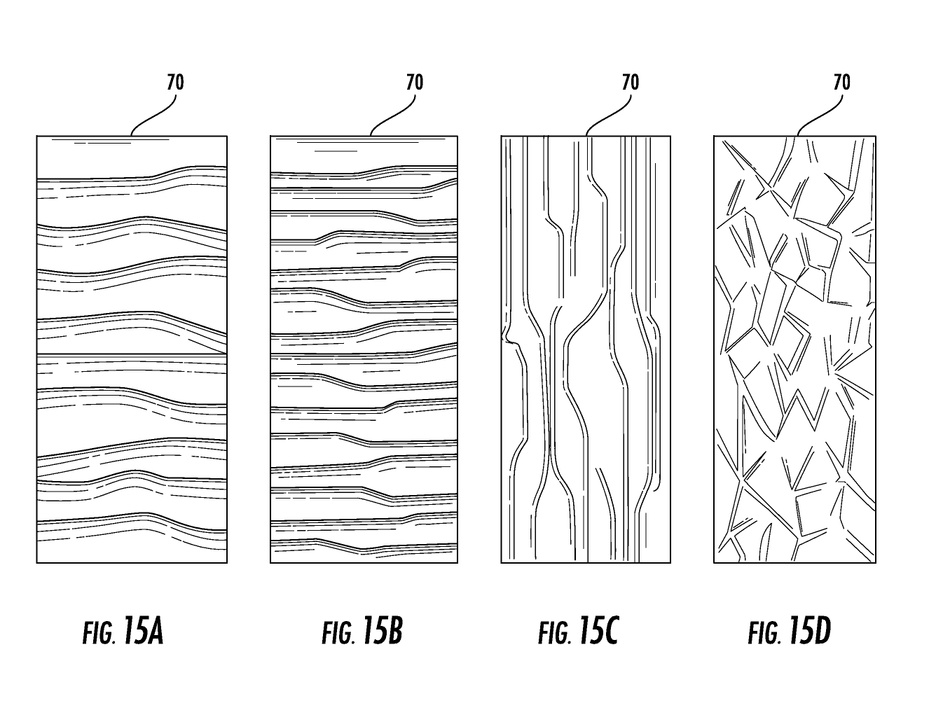

FIGS. 15A-15D show a variety of surface finishes that may be applied to the panels 70 of the containers to vary the aesthetics of the containers. For example, FIG. 15A shows a paper look finish; FIG. 15B shows a metal sediment finish; FIG. 15C shows a dark metal finish and FIG. 15D shows a stained glass finish formed of creased metal with an iridescence finish. Panels having different finishes may be secured to the base and top to provide different visual appearances of the system.

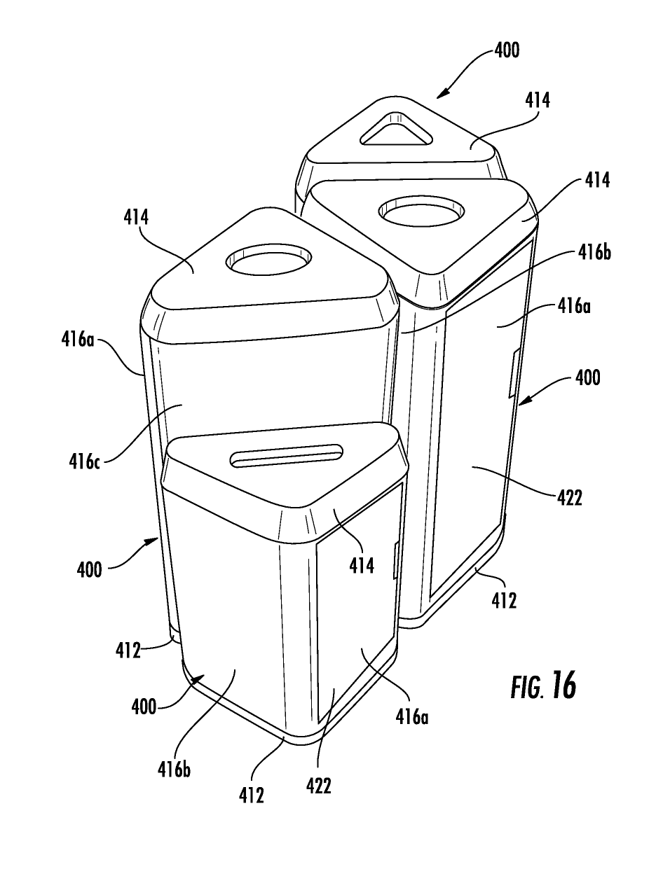

FIG. 16 shows an embodiment of the containers 400 having other than a rectangular base. In the embodiment of FIG. 16 the containers 400 have a triangular shape that may be nested with one another to create a system having an overall generally rectangular footprint. In such an embodiment the footprint of all of the containers is identical. The containers 400 may also be arranged such that the footprint of the system is other than rectangular. FIG. 16 also shows containers having different heights. Containers of different heights may be used in any of the embodiments described herein. As shown in FIG. 16 each container 400 comprises a generally triangular base 412 with a triangular body 416 defined by three side walls 416a, 416b and 416c. A door 422 may be located in one of the side walls as previously described such that this wall may be considered the front wall 416a of the container. One or both of the two remaining side walls 416b and 416c may be provided with the connection mechanism and alignment mechanism as previously described to secure the containers together. The containers may be formed of separate base 412, top 414 and body 416 where the body 416 may be formed of separate wall panels as described with respect to FIGS. 4 and 5.

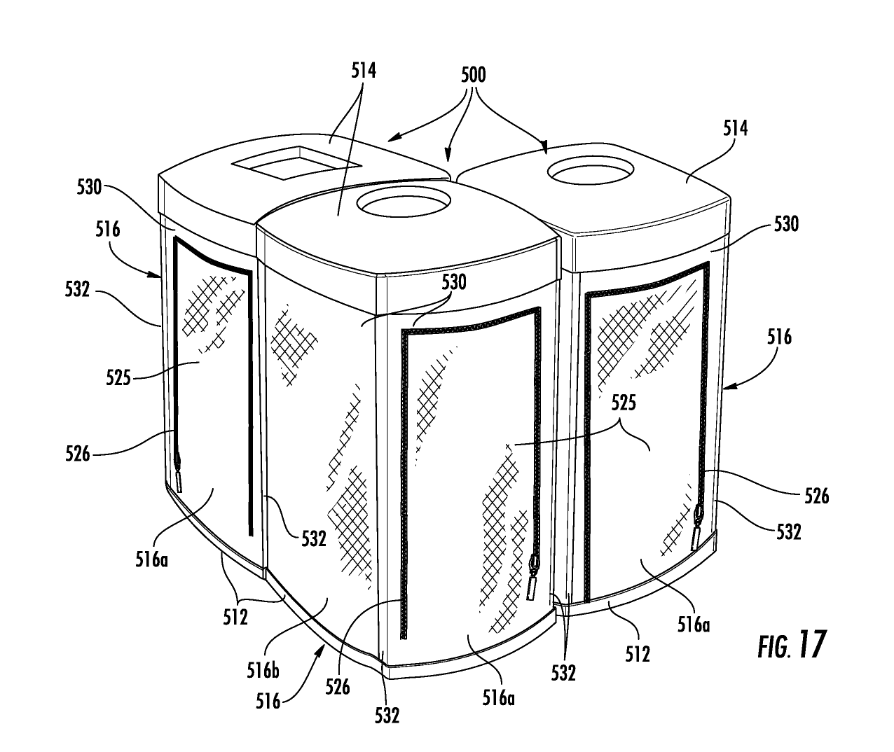

FIG. 17 shows a system similar to those as previously described where the containers 500 are made of a flexible fabric supported over a rigid frame. Each container may have a base 512 and a top 514 having the form and relative sizes as previously described. The side walls of the body 516 (while two side walls 516a and 516b are shown in FIG. 17, the containers 500 have four side walls) are formed of a fabric material 530 that is stretched over rigid members 532 that form at least the vertical side edges of the containers. In some embodiments the rigid members 532 may form only the vertical edges of the side walls or the rigid members 532 may form the top edge, bottom edge and vertical side edges of the side walls. In some embodiments a single piece of fabric may form all of the walls of the container. In other embodiments, each wall may be formed of an individual piece of fabric. The door 522 providing access to the interior of the containers may be formed as a zippered closed flap in one of the side walls. The flap 525 may be closed by a zipper 526 such that the flexible material of the side wall may be folded to open the container. The flap 525 may be zippered on three sides with the fourth side of the flap creating a living hinge about which the flap is folded to the open position. In some embodiments the top 514 may also be formed of flexible fabric supported on a rigid frame. The side walls may be provided with the connection mechanism and alignment mechanism as previously described to secure the containers together. The connection mechanism and alignment mechanism may be provided on the sides of the rigid base 512 and rigid top 514 rather than on the flexible side walls.

The system of the invention provides a consistent recycling solution that provides a clean, unified appearance. The number and types of waste streams may be varied to accommodate local laws, customs, rules or the like. The signage allows different visual clues and a variety of labeling options to be used and may be visible up to 10 to 20 feet. The use of a door on the vertical side walls of the containers provides good ergonomics that does not require a user to lift the discarded contents above the waist. The wall panels and doors may be locked or may be made of a transparent material for increased security. The system may be customized in size and shape. In one embodiment, the body 16, base 12 and top 14 may be made of stainless steel such as shown in FIG. 1; however, a wide variety of materials may be used. Use of stainless steel containers minimizes fire concerns. The system may be made of recycled materials, composite materials, poly-wood composites, resin or other suitable material. The tops may have different colors to provide a visual signal as to the appropriate contents. The system may be sold and delivered in a disassembled condition where an end user orders the components required to make a system of a desired configuration.

Although specific embodiments have been shown and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

1. A configurable container system comprising:
a first container having a first opening allowing access to the interior of the first container;
a second container having a second opening allowing access to the interior of the second container;
a first magnet provided on the first container and a magnetically attractive connector provided on the second container to releasably secure the first container to the second container.

2. The configurable container system of claim 1 wherein the magnetically attractive connector comprises a ferromagnetic material.

3. The configurable container system of claim 1 wherein the first magnet has a first polarity and the magnetically attractive connector comprises a second magnet having a second polarity.

4. The configurable container system of claim 1 comprising an alignment mechanism on the first container and the second container for aligning the first container relative to the second container.

5. The configurable container system of claim 4 wherein the alignment mechanism comprises a protrusion on one of the first container and the second container and a recess on the other one of the first container and the second container.

6. The configurable container system of claim 5 wherein the protrusion comprises a rounded convex protrusion and the recess comprises a rounded concave recess.

7. The configurable container system of claim 4 wherein the alignment mechanism comprises a protrusion on one of the first container and the second container and a recess on the other one of the first container and the second container and the first magnet comprises one of the protrusion and the recess and the magnetically attractive connector comprises the other one of the protrusion and the recess.

8. The configurable container system of claim 4 wherein the first magnet and the magnetically attractive connector are disposed opposite to one another when the alignment mechanisms of the first container and the second container are engaged with one another.

9. The configurable container system of claim 1 wherein the first container has a depth of a basic unit and a width of the basic unit and the second container has a second width and a second depth where at least one of the second width and the second depth is an integer multiple of the basic unit.

10. The configurable container system of claim 1 wherein the first container has a first top and the second container has a second top, the first opening being in the first top and the second opening being in the second top wherein one of the first top and the second top comprises a first section connected to a second section at a hinge such that the first section may move relative to the second section about the hinge to change the angle of the one of the first top and the second top relative to the first container and the second container, respectively.

11. The configurable container system of claim 1 wherein the first container comprises a body and a door in the body.

12. The configurable container system of claim 1 wherein the first container comprises at least a first wall panel and a second wall panel, the first wall panel and the second wall panel being independently connected to a base.

13. The configurable container system of claim 12 wherein the first wall panel comprises a pivoting door.

14. The configurable container system of claim 12 wherein the first wall panel comprises a frame supporting a pivoting door.

15. The configurable container system of claim 1 wherein the first container and the second container each comprise a triangular base supporting a triangular body wherein the first container and the second container are connected by engagement of the first magnet and the magnetically attractive connector to create a system having a rectangular footprint.

16. The configurable container system of claim 1 wherein the first container and the second container each comprise a base supporting a body wherein the body comprises a flexible fabric supported on a rigid frame.

17. A configurable container system comprising:
a first container having a first opening allowing access to the interior of the first container;
a second container having a second opening allowing access to the interior of the second container;
a connection mechanism releasably securing the first container to the second container;
an alignment mechanism aligning the first container and the second container comprising a protrusion on one of the first container and the second container and a mating recess on the other one of the first container and the second container.

18. The configurable container system of claim 17 wherein the protrusion comprises a magnet, the recess receiving the magnet.

19. The configurable container system of claim 17 wherein the protrusion comprises a convex protrusion and the recess comprises a mating convex recess.
